(19) United States
(12) Patent Application Publication
(10) Pub. No.: US 2011/0079313 A1
(43) Pub. Date: Apr. 7, 2011

(54) HOSE PUMPS

(75) Inventors: Ali Reza Kambiez Zandiyeh, Louth (GB); Marco Musto, Lincolnshire (GB)

(73) Assignee: Dunlop Oil & Marine Limited, Grimsby (GB)

(21) Appl. No.: 12/736,541

(22) PCT Filed: Jan. 22, 2009
(86) PCT No.: PCT/GB2009/000166

§ 371 Date: Dec. 20, 2010

(30) Foreign Application Priority Data
Apr. 17, 2008 (GB) 0806962.7

(51) Int. Cl. F16L 11/20; F16L 11/00

(52) U.S. Cl. 138/109; 138/132; 138/133

(57) ABSTRACT

A hose for a hose pump comprises inner plies (20) and outer plies (22) separated by a filler layer (24). The inner (20) and outer plies (22) are helically wound in opposite directions and the inner plies (20) are at a shallower angle than the outer plies (22).

The present invention relates to hose pumps and in particular to the design of hoses suitable for hose pumps. Hose pumps have application in a variety of systems including, for example, power generation systems.

It is known to provide a hose pump which comprises a hose which is arranged to be stretched and relaxed, and to contract on stretching and expand again when relaxed. This contraction and expansion is used to pump liquid within the hose.

The requirements of a hose for a hose pump are different from those of most other types of hose. In particular it is desirable that the hose for a hose pump should contract significantly on axial stretching, and that it should be able stretch relatively easily and by a relatively large amount to produce the radial contraction and the pumping effect. Typically the hose of a hose pump might be arranged to stretch by about 20%. This is in contrast to more conventional hoses, for example for the transport of oil, which might only be expected to stretch by around 2%. As a result of the high degree of stretching required of this type of hose, it is desirable for the hose to be able to withstand the associated levels of strain and to have good fatigue life.

Other characteristics of the hose, such as the axial stiffness and the hysteretic damping, need to be tuned to suit the particular application. For example, where the hose pump is part of a wave powered energy generation system, these parameters need to be tuned to maximize the efficiency of energy capture from the system.

Accordingly the present invention provides a hose for a hose pump comprising inner plies and outer plies separated by a filler layer, wherein the inner and outer plies are helically wound in opposite directions and the inner plies are at a shallower angle than the outer plies.

The plies are made of wire, in particular metal wire, for example steel wire.

The radius of the inner plies from the centre of the hose may be in the range from 20% to 90% of the radius of the outer plies.

The angles of the plies and the thickness of the filler layer may be selected so that the twisting effects of the inner and outer plies produced by stretching the hose are substantially balanced. This can help to prevent twisting of the hose as it is stretched in use.

The present invention further provides a hose assembly comprising a hose according to the invention and an end fitting wherein the end fitting comprises a tubular portion having a first end over which and end of the hose extends, and a second end, with a fitting flange located at the second end, the fitting having first and second retention beads formed on the outer surface of the tubular portion for retention of the inner and outer plies respectively.

The filler layer preferably decreases in thickness towards the end of the hose.

The present invention further provides a hose assembly comprising a hose having inner and outer plies with a filler layer between the plies, and an end fitting wherein the end fitting comprises a tubular portion having a first end over which an end of the hose extends, and a second end with a fitting flange located at the second end, the fitting having first and second retention beads formed on the outer surface of the tubular portion for retention of the inner and outer plies respectively, wherein the filler layer decreases in thickness towards the end of the hose.

The filler layer may decreases in thickness over at least a part of the hose which is beyond the first end of the end fitting. That part of the hose may be unsupported by the end fitting. The filler layer may be of substantially constant thickness from the first end of the fitting to the first retention bead. The filler layer may decrease in thickness, continuously or in steps, and for all or part of the distance, between the first and second retention beads.

The present invention further provides a hose end fitting comprising a tubular member having a first end arranged to be located within a hose and a second end with a connection flange provided at the second end, wherein a flexible extension is provided at the first end of the fitting.

The flexible extension may be formed of a different material from the tubular member. For example it may be formed of a more flexible material than the tubular member. The extension may be tubular. The extension may decrease in thickness towards its free end, over at least a part of its length.

Preferred embodiments of the present invention will now be described by way of example only with reference to the accompanying drawings in which:

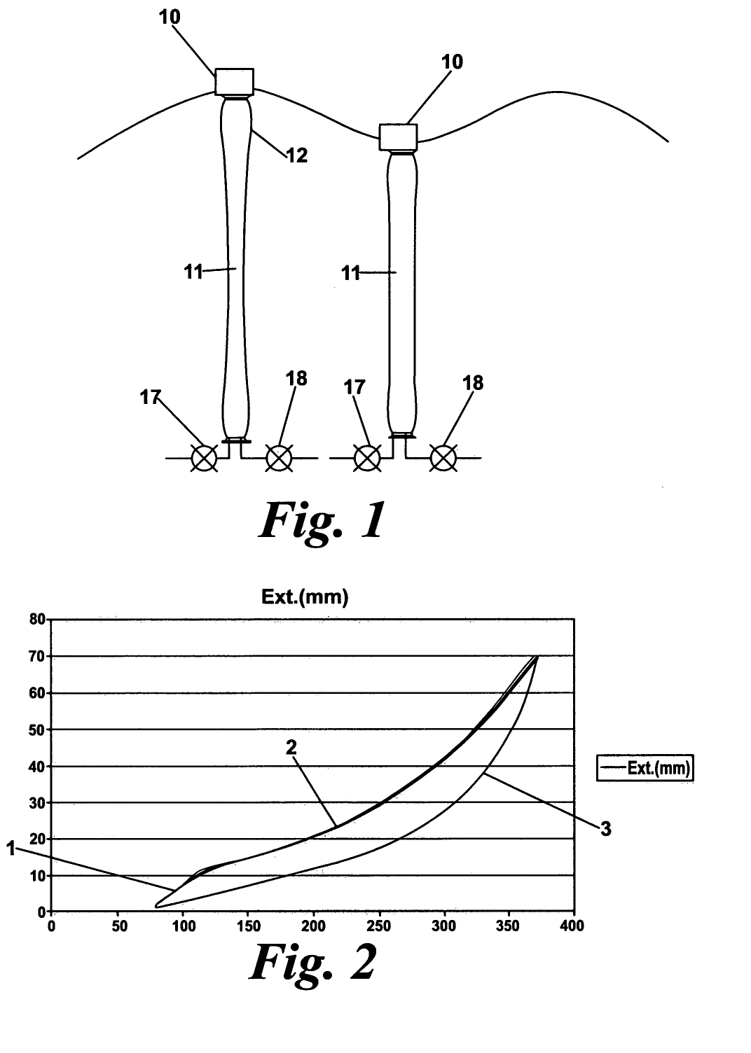

FIG. 1 is a schematic view of a hose pump according to an embodiment of the invention;

FIG. 2 shows the cycle of operation of the hose pump of FIG. 1;

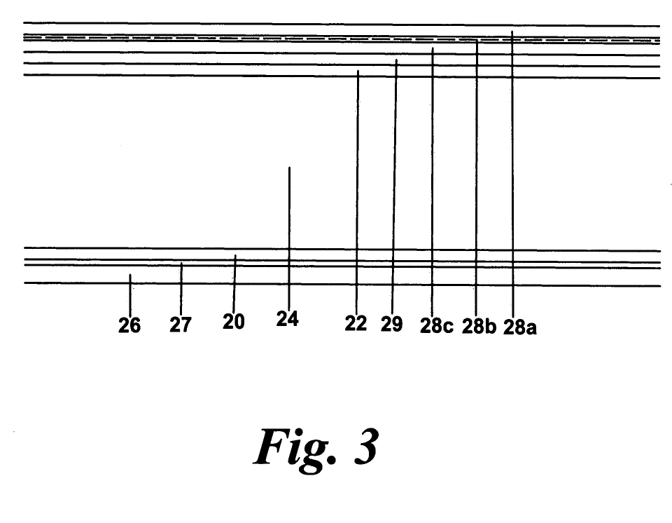

FIG. 3 is a schematic section through one wall of a hose of the pump of FIG. 1;

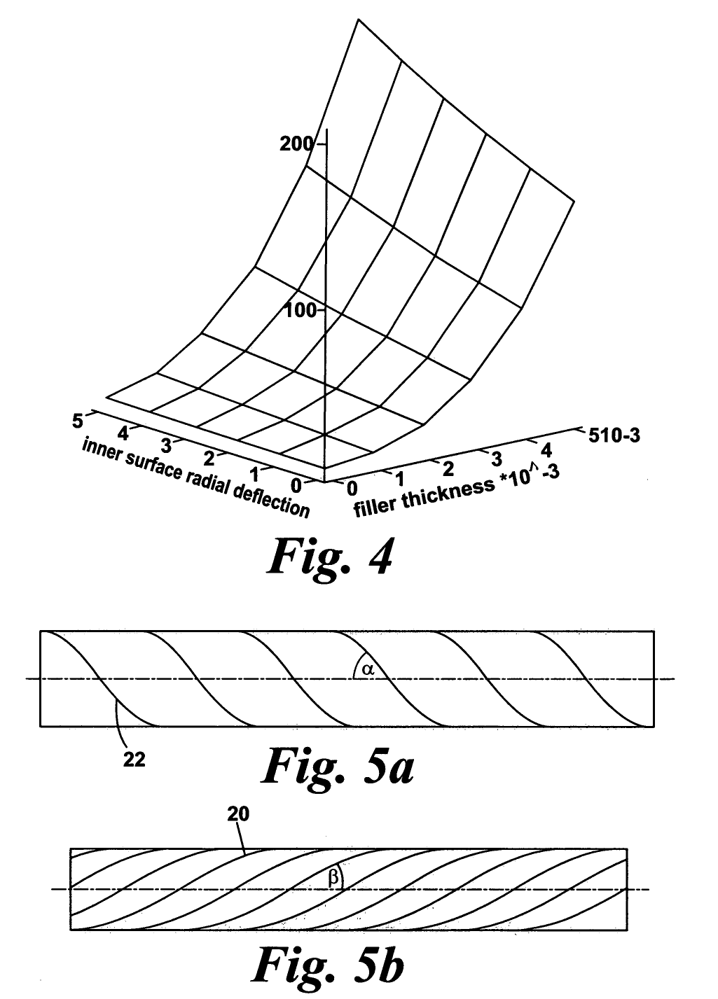

FIG. 4 shows the effect of thickness of the filler layer on the energy required for radial contraction of the hose of FIG. 3;

FIGS. 5a and 5b are schematic views of reinforcement windings of the hose of FIG. 2;

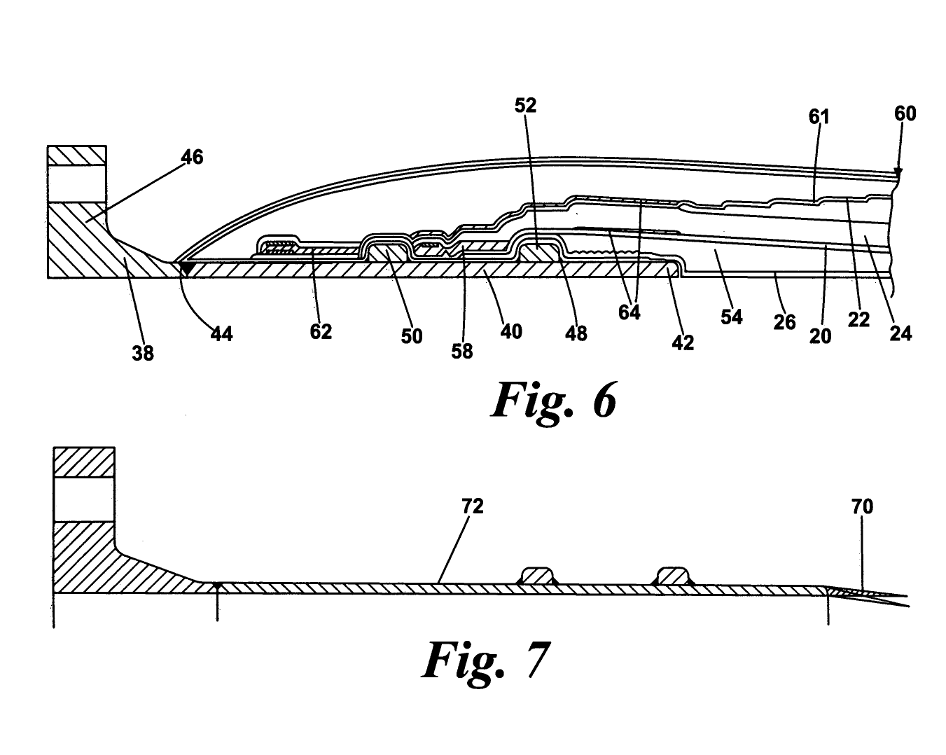

FIG. 6 is a section through a hose end fitting of the hose of FIG. 2; and

FIG. 7 is a section through a hose end fitting according to a further embodiment of the invention.

Referring to FIG. 1 a hose pump comprises a floating buoy 10 arranged to float on the surface of the water, a length of hose 11 having its upper end 12 connected to the buoy 10 and its lower end 13 connected to an anchor point 14 so that it is substantially fixed. In operation waves on the surface of the water cause the buoy 10 to rise and fall thereby stretching and relaxing the hose 11 causing it to contract and expand radially. The hose 11 is sealed at its top and bottom ends, and the interior of the hose is connected to a power generator 15 via an inlet valve 17 and an outlet valve 18. The contraction and expansion changes the volume inside the hose 11 which pumps water out of the hose via the outlet valve 18 and back into it via the inlet valve 17, forcing the water through the power generator 15.

Referring to FIG. 2, starting with the hose 11 full of water, the hose pump goes through three main phases in its pumping cycle. In the first phase, marked 1 on FIG. 2, both valves 17, 18 are closed and the hose is stretched. As a result of this the pressure of the water in the hose increases. Then the outlet valve 18 is opened and the hose is stretched further, with the water in the hose remaining at constant pressure as some of it is pumped out. This is shown as phase 2 on FIG. 2. At the top of the axial stretch cycle, i.e. at maximum extension of the hose 11, the pressure of the water drops. Then the outlet valve is closed, and the inlet valve 17 opened, and the hose starts phase 3 during which it contracts back to its initial length, drawings water into the hose through the inlet valve 17. As there is hysteresis in the hose, work is done in axial stretching and relaxing of the hose, and a hysteretic damping effect is produced.

Referring to FIG. 3, the hose used in the hose pump of FIG. 1 comprises inner plies 20 and outer plies 22 separated by a layer of filler 24. Each of the inner and outer plies 20, 22 comprises a series of spirally wound wire cords, with diameters of 1.5 to 2.0 mm, embedded in a layer of polymeric material, for example SBR rubber, which in this case is 2.5 mm thick. The density of the wires is in this case 39 ends per 100 mm. Obviously these values will vary for hoses of different characteristics. A breaker 25 and a liner 26 are provided inside the inner plies 20, the liner 26 forming the inner surface of the hose. A cover 28 comprising a sub-cover 28a, a breaker 28b, and a main outer cover 28c, is provided outside the outer plies 22, the main outer cover 28c forming the outer surface of the hose.

In this embodiment, the dimensions and properties of the various layers of the hose are summarized in the following table:

| | | | Angle and | |
|---|---|---|---|---|
| | | | packing | |
| | | | density | |
| | | | (degrees/ | |
| Thickness | | Material | ends per | Component |
| (mm) | Material Type | Description | 100 mm) | Name |
| 2.5 | Polymer | Natural-SBR | — | Lining |
| | | Blend | | |
| 1 | Fabric | Nylon/ | 54°/101 | Breaker |
| | embedded in | Natural-SBR | | |
| | rubber | Blend | | |
| 5 | Wire | Steel braided | 42°/43 | Main Plies |
| | embedded in | cord/SBR | | |
| | rubber | compound | | |
| 24 | Polymer | Natural-SBR | — | Filler |
| | | Rubber | | |
| 2 | Wire | Steel braided | 48°/39 | Main Plies |
| | embedded in | cord/SBR | | |
| | rubber | compound | | |
| | Polymer | Natural | — | Sub-Cover |
| | | Rubber based | | |
| | | compound | | |
| 1 | Fabric | Nylon/ | 49°/101 | Holding Plies |
| | embedded in | Natural-SBR | | |
| | rubber | Blend | | |
| 2 | Polymer | Natural | — | Cover |
| | | Rubber based | | |
| | | compound | | |

The construction of the hose, including the dimensions and materials of the various layers, will affect its characteristics in various ways, and the construction selected can therefore be used to tune the hose characteristics as required. The way in which the various construction parameters affect the hose characteristics will now be described.

It will be appreciated that axial stretching of the hose will cause inward radial displacement of the two plies 20, 22. This is due to the inelasticity of the plies which are of wire and, because they cannot stretch, are forced radially inwards when their ends are pulled apart by stretching of the hose.

The thickness of the filler layer will affects the radial contraction of the inner surface of the hose on axial stretching. Neglecting the axial stretching of the filler layer 24 and assuming that its cross sectional area remains constant, it can be calculated that in response to radial contraction the radial thickness of the filler layer 24 must increase. This effect is used to provide a form of mechanical advantage which amplifies the pumping effect produced by stretching the hose. It can also be arranged to cooperate with the differential radial contraction of the inner and outer plies 20, 22 as will be described below.

The thickness of the filler layer 24 affects the axial stiffness of the hose 11. It will be appreciated that the thicker the layer of filler between the two plies 20, 22, the greater will be the difference in change of radius between the inner and outer plies on stretching and therefore the greater will be the work done to produce the radial contraction, and therefore the greater will be the stiffness of the hose in stretching. This can be described mathematically as follows.

The general solution for an axially symmetric loaded hollow cylinder for displacement u as a function of radius r is:

u(a,b,r)=ar+b/r

where a and b are constants.

The components of strain in the hollow cylinder having inner radius of innerradius and outer radius of outerradius are given by

$$[ \begin{matrix}{ɛ}_{r} \\ {ɛ}_{φ} \\ {ɛ}_{r φ}\end{matrix} ] = f ( innerradius , outerradius , r , a , b ) = [ \begin{matrix}a - b / {r}^{2} \\ a + b / {r}^{2} \\ 0\end{matrix} ]$$

In plane strain conditions, the stiffness as a function of Young's modulus E and Poisson ratio ν is:

$$stiffness ( E ) = \frac{E}{( 1 + v ) ( 1 - 2 v )} [ \begin{matrix}1 - v & v & v \\ v & 1 - v & v \\ v & v & 1 - v\end{matrix} ]$$

The strain σ is given by:

σ=stiffness(E)·ε

(ε, σ represent the stress and strain tensors)

Integration constants a and b are determined through imposing fixed displacements (deformations) of the inner and outer surfaces of the cylinder

$$\{ \begin{matrix}a \cdot innerradius + b / innerradius = innerdef \\ a \cdot outerradius + b / outerradius = outerdef\end{matrix}$$

The energy of deformation F as a function of the geometric, material properties and imposed displacements can be calculated as:

$$F ( inneradius , outerradisu , inenrdef , outerdef , a , b , E ) = \frac{1}{2} {\int }_{0}^{2 π} {\int }_{inner}^{outer} ( ɛ \cdot σ ) d V$$

Referring to FIG. 4, the energy required (i.e. work done) to contract the hose radially, as calculated above, can be plotted as a function of radial deflection of the inner surface of the hose and of filler thickness (for the hose in an un-stressed state). Any particular hose will follow a line of constant filler thickness, and as can be seen, the calculated energy for hose contraction increases with filler thickness as described above.

Another factor in the stretching stiffness of the hose is that resulting from the axial stretching of the filler layer and other components. However it has been found that the stiffness from axial contraction is, in many designs, at least as great as the stiffness from axial stretching.

Referring back to FIG. 2, the amount of hysteretic loss in the hose pump depends partly on the relaxation modulus. Generally, the lower the relaxation modulus, the bigger the hysteretic loss. Also the higher the bulk modulus the better the overall efficiency of the system. The material of the filler layer 24 can therefore be selected to tune these characteristics of the hose. As rubber is highly non-linear in stress strain is possible to choose a compound, or two different compounds, for the filler layer that produce different characteristics in different ranges of strain. For example the filler layer may be chosen to have one set of characteristics in the range of 0-20% strain, which is typical for axial strains, but different characteristics, for example lower modulus, in range of 20% to 50%, which is typical for radial strains.

Another important effect which is utilized in this embodiment is the torsional effect produced by axial stretching of the helically wound plies 20, 22. It will be appreciated that if helically wound plies are stretched axially, they tend to unwind, producing a twisting effect on the hose. This twisting effect varies as the angle of the plies with respect to the longitudinal direction varies. For very shallow angles, i.e. close to the longitudinal (axial) direction, the twisting effect is higher than for more open angles, i.e. closer to the circumferential direction. However another factor which affects the twisting torque is the diameter of the tubular formation of plies, measured from the central longitudinal axis of the hose. This is for two reasons. Firstly the greater the radius at which the plies are located, the greater will be the circumference of the layer of plies and therefore the more plies will be in the layer, and therefore the greater the torsional effect they will produce. Secondly since the twisting effect is a torque, for any particular number of plies giving a particular force on stretching, the torque will increase with distance from the central axis of the hose. Therefore, if the inner and outer layers of plies have the same density of plies at the same angle, the torsional effect of the outer plies will be greater than the torsional effect of the inner plies.

Referring to FIGS. 5a and 5b, in this embodiment the inner and outer plies 20, 22 are wound in opposite directions. This means that, on stretching of the hose, the inner and outer plies will tend to twist the hose in opposite directions, and the twisting effects of the two layers of plies will therefore at least partially cancel each other out. Furthermore, the plies of the inner layer 20 are wound at a shallower angle β than the angle γ of those in the outer layer 22 which are wound at a more open angle. By selection of the angles of the two sets of plies and matching them to the difference in diameter between the two layers of plies, the twisting effects of the two layers is arranged to be substantially balanced. Generally the angles of application will be in the range of 30° to 70° and normally within the range 36° to 50°. The difference in the diameter of the inner and outer layers of plies will obviously vary depending on the characteristics required, but typically the diameter of the layer of inner plies will be between 50% and 90%, though it will usually be greater than 60% and in fact in most cases more than 70% of the diameter of the layer of outer plies. The thickness of the filler layer 24 between the plies will generally be at least 20% of the total thickness of the hose wall, and in fact it will usually be more than 30% and in many cases more than 40%. In some preferred embodiments the filler layer will be more than 50% of the thickness of the hose wall, in the relaxed state.

Another effect that is relevant is the radial contraction produced by axial stretching of the helical plies. Assuming the plies are inelastic, the radial contraction on stretching depends on the winding angle of the plies. For plies at a very open angle, the radial contraction on stretching is lower than for plies at a shallower angle. Therefore in this embodiment the shallower angle inner plies will tend to contract radially on stretching more than the more open angle outer plies. This means that this difference in radial contraction helps to cause the radius of the inner plies to reduce by more than the radius of the outer plies on longitudinal stretching of the hose. This is therefore consistent with the effect described above whereby the filler layer tends to increase in thickness as it contracts radially inwards, and allows the radial load on the plies, caused by the resistance to radial contraction from the filler layer, to be balanced between the two layers of plies 20, 22.

It will be appreciated that by tuning the modulus of elasticity of the filler layer, and the thickness of the filler layer, as well as other parameters of the hose such as the wire binding angles, allows the characteristics of the hose two be tuned to meet a required specification. In this embodiment the characteristics of the hose are chosen to provide an efficient wave powered hose pump. This requires an optimum degree of hysteretic damping and axial stiffness, which are chosen to optimize the efficiency of energy extraction by the system in given sea conditions, and also the maximum pumping volume consistent with the stiffness and damping characteristics. Another important feature of this embodiment is that the modulus is arranged to decrease with increasing strain, at least over part of the range of strains the hose is designed to withstand. Referring back to FIG. 4, the aim of this is to reduce the non-linearity of the strain/load characteristic, which in turn can help to maintain a more constant relationship between volume displacement and axial stretching of the hose.

Referring to FIG. 6, a steel end fitting 38 for the hose of FIGS. 2 and 3 comprises a tubular portion 40 having a first end 42 that is arranged to be inserted into the end of the hose, and a second end 44 at which the fitting widens to form a connection flange 46. Two circumferential retention beads 48, 50 are provided on the outer surface of the tubular portion 40, the first one 48 being closer to the first end 42 of the tubular member, but spaced from it, and the second one 50 being closer to the flange 46. The lining 26 of the hose has the same inner diameter as the end fitting 38 where it meets the first end 42 of the fitting, and then increase in diameter where it extends over the outer surface of the end fitting 38. The inner plies 20 extend from the main part of the hose to the top surface 52 of the first bead 48 at a substantially constant radius, or a radius that varies very gradually. An inner filler layer 54 is provided between the lining 26 and the inner plies 20 which is thinner between the first bead 48 and the first end 42 of the end fitting than it is in the main part of the hose beyond the first end 42 of the end fitting, as the distance between the lining 26 and the inner plies 20 varies. The inner filler layer 54 stops at the first bead 48 and in the region 56 of the end fitting between the two beads 48, 50, the inner plies 20 are bound to the end fitting by binding wire 58.

The main filler layer 24 decreases in thickness between a boundary point 60 beyond the first end 42 of the fitting 38 and axially spaced away from the end fitting 38, and the first end 42 of the fitting 38. This is achieved by staggering the ends of the layers of polymeric material of which the filler layer 24 is formed, so that the total thickness of the filler layer decreases in steps over that region of the hose which is not directly supported on the end fitting. The diameter of the outer plies 22 therefore also decreases, in steps, between the boundary point 60 and the end 42 of the fitting. Over the part of the end fitting between its inner end 42 and the first bead 48, the main filler layer 24 is of substantially constant thickness and the outer plies are therefore at a substantially constant diameter. The main filler layer 24 decreases again in thickness, between the two beads 48, 50 where it extends over the binding wires 58, and ends at the inner side of the second bead 50.

It is an advantage of the gradual reduction in diameter of the outer plies 22, and the gradual reduction in thickness of the filler layer 24, that the stresses in the hose in the region of the end fitting vary gradually, rather than changing abruptly as would tend to be the case if the filler layer varied in thickness more rapidly along its length. Also this gradual change or radius helps to avoid any significant bending of the reinforcement wires on stretching and relaxing of the hose. A further advantage of the gradual variation of in thickness of the filler layer 24 is that it allows for a gradual variation of shear strain through its thickness. This is important since rapid variations in shear strain are detrimental to fatigue life.

Where they pass over the second bead 50, and beyond it between the second bead 50 and the flange 46, the inner and outer plies 20, 22 are in contact with each other. In the region beyond the second bead 50 the two layers of plies 20, 22 are bound to the end fitting by an outer set of binding wires 62. It will be appreciated that the inner binding wires 58 together with the first bead 48 provide most of the securing for the inner plies 20, and the outer set of binding wires 62 together with the second bead 50 provide most of the securing of the outer plies 22.

Strapping 64 which in this case is formed of an aramid, such as Kevlar is wound around the inner plies 20 in the region between the end 42 of the fitting 38 and the first bead 48. Similar strapping is also provided over the outer plies 22 all the way from the end 42 of the fitting to the inner side of the second bead 50. This strapping 64 is arranged to provide a controlled and gradual variation in movement of the hose components relative to the end fitting 38, thereby to prevent rapid variations in strain. It also prevents any significant movement of the hose in areas where fretting might occur, such as over the beads. The strapping extends to the end of the fitting 38 so that the required control is provided over the whole length of the end fitting 38.

It will be appreciated that at the point at the very end of the hose fitting 42, there is a sharp transition between the part of the hose which is supported on the hose fitting 38 and cannot contract radially, and the part of the hose which is not supported and which therefore can contract radially. This can put a lot of strain on that part of the hose. Therefore in a further embodiment of the present invention, as shown in FIG. 7, a flexible extension 70 is provided on the inner end of the steel end fitting 72. The extension 70 is made of a more flexible material than the steel end fitting, and in this case is made of polymeric material. The extension 70 is also arranged to increase in flexibility in the inward direction away from the steel end fitting. To achieve this, the extension, which is tubular with the same constant inner diameter as the steel end fitting 72, and coaxial with it, is arranged to decrease in thickness in the direction away from the steel end fitting. This means that when the hose supported on the end fitting 72 is subject to a stretching force, the ease with which it can contract, and therefore the degree of radial contraction it undergoes, will vary gradually between the part of the hose supported on the steel end fitting and the part of the hose that is beyond the end of the extension 70. This helps to reduce the strain in the hose at the end of the end fitting, and therefore increases the durability of the hose assembly. In this case the extension is about 10% of the length of the end fitting, but it could be between 5% and 20%, or as little as 2% or as much as 30%.

In other embodiments, the extension can be of constant thickness, or only vary in thickness along a part of its length.

While this end fitting arrangement is particularly desirable in hose pump systems where the degree of stretching is significantly higher than in normal hoses, it can also be used in other types of hose system such as oil transport hoses.

1. A hose for a hose pump comprising inner plies and outer plies and a filler layer, wherein the inner and outer plies are separated by the filler layer, wherein the inner and outer plies are helically wound in opposite directions at respective winding angles, and the winding angle of the inner plies is shallower than the winding angle of the outer plies.

2. A hose according to claim 1 wherein the plies are less elastic than the filler layer.

3. A hose according to claim 1 wherein the plies are made of wire.

4. A hose according to claim 1 wherein inner and outer plies are each at a respective radius from the center of the hose, and the radius of the inner plies is in the range from 20% to 90% of the radius of the outer plies.

5. A hose according to claim 1 wherein the filler layer is of polymeric material.

6. A hose according to claim 1 wherein the inner and outer plies are each arranged to produce a twisting effect on stretching of the hose, and the winding angles of the plies and the thickness of the filler layer are selected so that the twisting effects of the inner and outer plies are substantially balanced.

7. (canceled)

8. An assembly according to claim 9 wherein the filler layer decreases in thickness towards the end of the hose.

9. A hose assembly comprising a hose having an end and comprising inner and outer plies with a filler layer between the plies, and an end fitting wherein the end fitting comprises a tubular portion having an outer surface, a first end over which the end of the hose extends, and a second end with a fitting flange located at the second end, the fitting having first and second retention beads formed on the outer surface of the tubular portion for retention of the inner and outer plies respectively.

10. An assembly according to claim 8 wherein the hose has a part which is beyond the first end of the end fitting, and the filler layer decreases in thickness over said part of the hose.

11. An assembly according to claim 8 wherein the filler layer is of substantially constant thickness from the first end of the fitting to the first retention bead.

12. An assembly according to claim 10 wherein the filler layer decreases in thickness between the first and second retention beads.

13. A hose end fitting comprising a tubular member having a first end arranged to be located within a hose and a second end with a connection flange provided at the second end, wherein a flexible extension is provided at the first end of the fitting.

14. A hose fitting according to claim 13 wherein the flexible extension is formed of a different material from the tubular member.

15. A hose fitting according to claim 14 wherein the extension is formed of a more flexible material than the tubular member.

16. A hose fitting according to claim 14 wherein the extension is formed of polymeric material.

17. A hose fitting according to claim 13 wherein the extension is tubular.

18. A hose fitting according to claim 13 wherein the extension decreases in thickness towards its free end.

19. (canceled)
